(19) United States
(12) Patent Application Publication
(10) Pub. No.: US 2025/0111589 A1
(43) Pub. Date: Apr. 3, 2025

(54) ENVIRONMENT-MODELING BASED CAMERA ADAPTATION FOR PASSTHROUGH EXTENDED REALITY SYSTEMS

(71) Applicant: Apple Inc., Cupertino, CA (US)

(72) Inventors: Simon Fortin-Deschenes, Santa Clara, CA (US); Luke A Pillans, San Diego, CA (US); Anselm Grundhoefer, Campbell, CA (US); Christian I Moore, Sunnyvale, CA (US); Seyedkoosha Mirhosseini, Santa Clara, CA (US)

(21) Appl. No.: 18/826,434

(22) Filed: Sep. 6, 2024

Related U.S. Application Data
(60) Provisional application No. 63/541,104, filed on Sep. 28, 2023.

(51) Int. Cl. G06T 15/06; G06F 3/01; G06T 5/70; G06T 5/73; G06V 10/56; G06V 10/60; G06V 10/764

(52) U.S. Cl. CPC G06T 15/06; G06F 3/013; G06T 5/70; G06T 5/73; G06V 10/56; G06V 10/60; G06V 10/764

(57) ABSTRACT

Various implementations provide passthrough video based on adjusting camera parameters based on environment modeling. An environment characteristic may be determined based on modeling the physical environment based on sensor data captured via one or more sensors. For example, this may involve determining environment light source optical characteristics, environment surfaces optical characteristics, a 3D mapping of the environment, user behavior, a prediction of optical characteristics of light coming in the camera, and the like. The method may involve, based on the environment characteristic, determining a camera parameter for an image captured via the image sensor. For example, the method may determine exposure, gain, tone mapping, color balance, noise reduction, sharpness enhancement. The method may determine the camera parameter based on user information, e.g., user preferences, user activity, etc. The method may involve providing passthrough video of the physical environment based on the determined camera parameter.

### CROSS-REFERENCE TO RELATED APPLICATIONS

This application claims the benefit of U.S. Provisional Application Ser. No. 63/541,104 filed Sep. 28, 2023, which is incorporated herein in its entirety.

### TECHNICAL FIELD

The present disclosure generally relates to improving the appearance of video images captured and displayed by electronic devices and more specifically to systems, methods, and devices that adaptively adjust passthrough video characteristics to account for the environment depicted in the video and other circumstances.

### BACKGROUND

Extended reality (XR) devices can provide depictions or other views of physical environments around the devices. In some cases, such depictions or other views are provided by providing passthrough video, e.g., video images that are captured by outward facing image sensors and used to provide live views of the surrounding physical environment. The image sensors used in such passthrough video techniques may not be adequately or optimally adapted to account for that surrounding physical environment and other circumstances.

### SUMMARY

Various implementations disclosed herein provide passthrough video based on adjusting camera parameters (e.g., exposure, gain, tone mapping, color balance, noise reduction, sharpness enhancement) based on environment modeling and/or other circumstances. In some exemplary implementations, a processor executes instructions stored in a computer-readable medium to perform a method. The processor may be included in an electronic device that has one or more sensors comprising an image sensor. The method may involve capturing sensor data corresponding to a physical environment via the one or more sensors. The method may involve, for example, capturing an image, depth data, motion data, temperature data, humidity data, audio data, etc.

The method may involve determining an environment characteristic based on modeling the physical environment based on sensor data captured via the one or more sensors. For example, this may involve determining environment light source optical characteristics, environment surfaces optical characteristics, a 3D mapping of the environment, a user behavior in the environment, a prediction of optical characteristics of light coming into the camera, and the like.

The method may involve, based on the environment characteristic, determining a camera parameter for an image captured via the image sensor. For example, the method may determine exposure, gain, tone mapping, color balance, noise reduction, sharpness enhancement. The method may, additionally or alternatively, determine the camera parameter based on user information, e.g., user preferences, user activity, etc. The method may involve providing (e.g., capturing, modifying, presenting, etc.) passthrough video of the physical environment including one or more captured images based on the determined camera parameter.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory, computer-readable storage medium stores instructions, which, when executed by one or more processors of a device, cause the device to perform or cause performance of any of the methods described herein. In accordance with some implementations, a device includes one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example of an electronic device used within a physical environment in accordance with some implementations.

FIG. 2 illustrates an example of environment modeling of the physical environment of FIG. 1 in accordance with some implementations.

FIG. 3 illustrates a parameter adjustment process in accordance with some implementations.

FIG. 4 is a flowchart illustrating an exemplary method of providing passthrough video based on adjusting camera parameters based on environment modeling and other circumstances in accordance with some implementations.

FIG. 5 illustrates an exemplary device configured in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

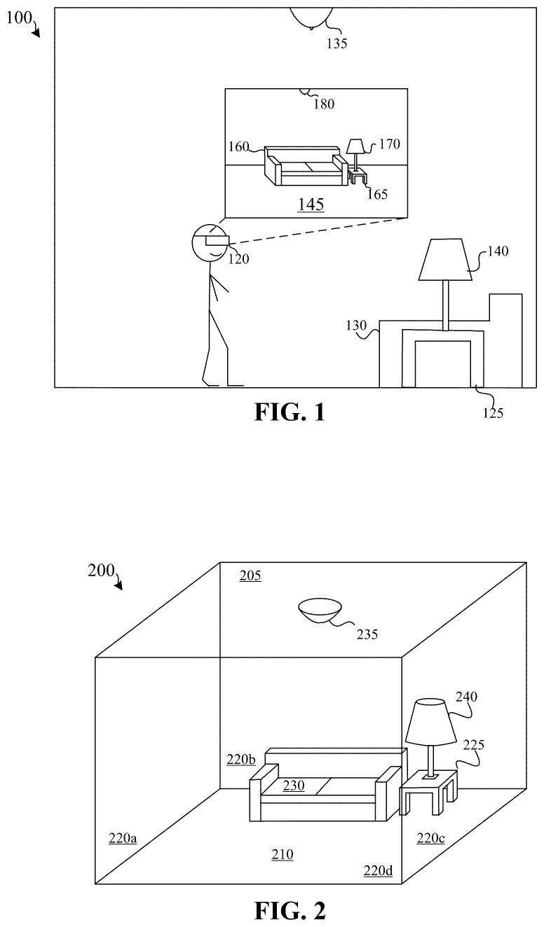

FIG. 1 illustrates an example of an electronic device 120 used by a user within a physical environment 100. A physical environment refers to a physical world that people can interact with and/or sense without the aid of electronic systems. Physical environments, such as a physical park, include physical articles, such as physical trees, physical buildings, and physical people. People can directly sense and/or interact with the physical environment, such as through sight, touch, hearing, taste, and smell. In FIG. 1, the physical environment 100 is a room that includes a sofa 130, a table 125, a lamp 140, and an overhead light 135.

In the example of FIG. 1, the electronic device 120 is illustrated as a single device. In some implementations, the electronic device 120 is worn by a user. For example, the electronic device 120 may be a head-mounted device (HMD) as illustrated in FIG. 1. Some implementations of the electronic device 120 are hand-held. For example, the electronic device 120 may be a mobile phone, a tablet, a laptop, and so forth. In some implementations, functions of the electronic device 120 are accomplished via two or more devices, for example, additionally including an optional base station. Other examples include a laptop, desktop, server, or other such devices that includes additional capabilities in terms of power, CPU capabilities, GPU capabilities, storage capabilities, memory capabilities, and the like. The multiple devices that may be used to accomplish the functions of the electronic device 120 may communicate with one another via wired or wireless communications.

Electronic device 120 captures and displays passthrough video of the physical environment 100. In this example, an exemplary frame 145 of the video is captured and displayed at the electronic device 120. The frame 145 (and additional frames) may be captured and displayed in a serial manner, e.g., as part of a sequence of captured frames in the same order in which the frames were captured. In some implementations the frame 145 is displayed approximately simultaneously with its capture, e.g., during a live video feed. In some implementations, the frame 145 is displayed after a latency period or otherwise at a time after the recording of the video. The frame 145 includes a depiction 160 of the sofa 130, a depiction 165 of the table 125, a depiction 170 of the lamp 140, and a depiction 180 of the overhead light 135. One or both of the light sources (e.g., the lamp 140 and the overhead light 135) may contribute to the amount of light, flicker, and other characteristics affecting the appearance of in the passthrough video that is captured. In addition, movement of the device 120 (e.g., as the user rotates their head) may result in motion blur. The camera(s) capturing the passthrough video may be adapted to account for the physical environment, for example, based on modeling the 3D environment and/or may be adapted based on other circumstances such as user information.

In some implementations, an HMD is configured with video passthrough and is enabled to adaptively change camara parameters to reduce under-desirable appearance attributes of the video passthrough. Some implementations model a 3D environment and/or determine an environment characteristic (e.g., a 3D mapping of light sources/surfaces in the environment) and use that environment characteristic to adjust exposure to reduce flicker, blur, and/or otherwise improve video appearance. In some implementations, a 3D map such as a SLAM map is generated based on sensor data on an HMD and used adjust camera parameters. The 3D map may be updated continuously, e.g., with a specific, flexible update rate. Additional data such as time of day, environment brightness, semantic segmentation, floor plan, and/or occlusion understanding may additionally, or alternatively, be used. Environment characteristics, time of day, environment brightness, semantic segmentation, floor plan, occlusion understanding, motion data, and/or any other relevant factors may be used to compute optimum exposure parameters during video capture, e.g., during the provision of passthrough video on an HMD.

In some implementations, environment characteristics are stored persistently. 3D information about an environment can be updated and made more accurate over time as a user uses a device (and/or other devices) in the environment. The data may persist over time and be used in different user sessions occurring at different times and days.

A persistent mapping can be adjusted over time, e.g., based on sensor data obtained over the course of time. A persistent map may effectively store various types of information about a physical environment for later use, e.g., for adjusting exposure at later points in time based on an understanding of the environment known from prior user experiences in the environment. For example, at a later point in time, an HMD may determine its 3D position within the environment and relative to the 3D positions of light sources in a 3D mapping of the environment and, based on the environment characteristics from the 3D mapping, determine whether and how to adapt camera parameters to provide a desirable user experience.

Lights source information may be incorporated into environment characteristic data, e.g., a 3D mapping, using various techniques. In one example, images of the physical environment are obtained and assessed to identify bright areas, and those bright areas are processed to identify and assess the characteristics of the light sources within the 3D environment.

In some implementations, a device operates in one or more camera capture modes. For example, the device may operate according to a first flicker compensation mode (e.g., based on only live flicker sensor data) until environment characteristic data (e.g., a 3D mapping) is developed, and then operate in a second flicker compensation mode (e.g., based on the 3D mapping and/or live flicker sensor data).

In some implementations, a 3D mapping of a physical environment identifies the 3D locations, shapes, flicker rates, brightness, and/or other attributes of one or more light sources in the physical environment. Flicker attributes may be based on historical, previously-obtained sensor data. In some implementations, a 3D mapping is based on a SLAM process (e.g., a VIO SLAM process) that is executed initially, periodically, and not necessarily updated during an experience in which flicker compensation is provided. The 3D mapping may be updated over time based on flicker sensor data.

A 3D mapping may provide a persistent digital map of a physical environment. It may include information about light source locations and attributes, surface locations and attributes, semantic data (e.g., identifying object types, material types, etc.), and/or other information about the environment from which flicker objectionability and other lighting characteristics may be estimated.

In some implementations, based on current conditions, a score for each of one or more light sources in a physical environment is determined and used to determine which (0 or more) of the light sources are providing objectionable flicker that should be adjusted for, e.g., by adjusting exposure. A given light source may be associated with an exposure time/threshold at which flicker is expected to become objectionable to an average observer or to the specific user.

In some implementations, where a user is looking in a passthrough view of a physical environment is used to determine if and how to adjust exposure to account for flicker. Flicker adjustment thus may occur in a given environment when the user looks at a first area but not occur in that same environment when the user looks at a second, different area. Similarly, flicker adjustment (e.g., for a dim lamp) may occur while an overhead light is off and the overall brightness in the environment is low but may not occur while the overhead light is on and the overall brightness in the environment is high. The overall brightness may decrease the visibility/objectionability of flicker from the lamp.

In some implementations, a user's motion, e.g., head rotation, is assessed in determining how to adjust camara parameters. For example, it may balance the appearance of flicker and the appearance of blur in passthrough video. For example, with a stationary head (and device), flicker compensation may be performed to account for a flicker light source. However, with a quickly rotating head (and device), such flicker compensation may be unnecessary (given the difficulty in perceiving the flicker while rotating one's head) or outweighed by a requirement to reduce blur, e.g., by adjusting the exposure according to blur reduction parameters. Balancing flicker and blur may also account for other factors. For example, in an environment with striped walls, head motion may result in a lot of objectionable blur (and thus blur reduction may be prioritized over flicker reduction), while in an environment with solid color walls and limited spatial contrast on surfaces, head motion may not result in much objectionable blur (and thus flicker reduction may be prioritized over blur reduction).

Other factors include whether virtual content is added to the passthrough content, e.g., adding a virtual user interface menu or partially opaque virtual content, how content of the physical environment is occluded in the passthrough video, display brightness, e.g., in the area where flicker occurs, weighting metrics that quantify the relative importance of blur and flicker, the size of the physical environment and/or distance of areas in view, the user's current task, the user's preferences with respect to flicker, blur, or other passthrough attributes, the exposure capabilities of the device (e.g., whether compensating for a particular flicker or motion is even possible), etc.

FIG. 2 illustrates an example of 3D data generated for the physical environment 100 of FIG. 1. In this example, a 3D mapping 200 of the physical environment 100 is generated based on image, depth, or other sensor data from device 120 (or another device). The 3D mapping 200 includes 3D representations 205, 210, 220a-d of the ceiling, floor, and walls of the physical environment 100. The 3D mapping 200 further includes a 3D representation 225 of table 125, a 3D representation 230 of couch 130, a 3D representation 240 of lamp 140, and a 3D representation 235 of overhead light 135.

The 3D mapping 200 stores information about the 3D locations of light sources (e.g., 3D representation 240 of lamp 140 and 3D representation 235 of overhead light 135) and information about those light sources, e.g., flicker rate, size, shape, bounding-boxed area, light color, light spectral range, brightness, current state (e.g., on, off, dimmed, etc.), type (e.g., window light, lamp, overhead, LED, LCD, OLED, incandescent, shaded, unshaded, diffuse, directed, angle of illumination, cone of illumination, etc.), and/or other attributes. Similarly, the 3D mapping stores information about the non-light surfaces (e.g., 3D representations 205, 210, 220a-d of the ceiling, floor, and walls, 3D representation 225 of table 125, 3D representation 230 of couch 130, etc.) and information about those surfaces, e.g., size, shape, reflectance properties, texture, spatial contrast, etc.

The 3D mapping 200 information is used to determine whether and/or how to adjust the parameters (e.g., exposure) of one or more cameras providing passthrough video to provide a desirable or optimal passthrough view. An observation point relative to the light sources and/or surfaces represented in the 3D mapping 200 may be determined and used in such determinations. For example, an observation point may be determined (based on the HMD's position) to be closer to the 3D representation 240 of the lamp 140 than to the 3D representation 235 of the overhead light 135 and the prioritization of the flicker of the lamp 240 prioritized over the flicker of the overhead light 135. In some implementations, a score for each light source is determined based on an observation point and the 3D mapping 200, e.g., based on how objectionable flicker from each light source is expected to be to an observer at the observation point based the environment characteristics represented in the 3D mapping 200. In some implementations device motion relative to light source location is also taken into account, e.g., prioritizing lights sources with respect to which the user is moving closer over light sources with respect to which the user is moving away.

Various implementations disclosed herein improve the appearance of video images captured and displayed by electronic devices. This may involve adaptively adjusting the exposure or other parameters of video capture to account for various factors related to video appearance including, but not limited to, light-based flicker, motion-induced blur, and noise. Some implementations create a more perceptually-stable passthrough video experience, providing image brightness stability, flicker reduction, and/or color stability. Some implementations, extend 3D VIO/SLAM or other environmental mapping, for example, adding a fourth dimension (time). Multi-modal information can be used to create or update a 3D map, which could be used to information camera/ISP parameters and/or decisions.

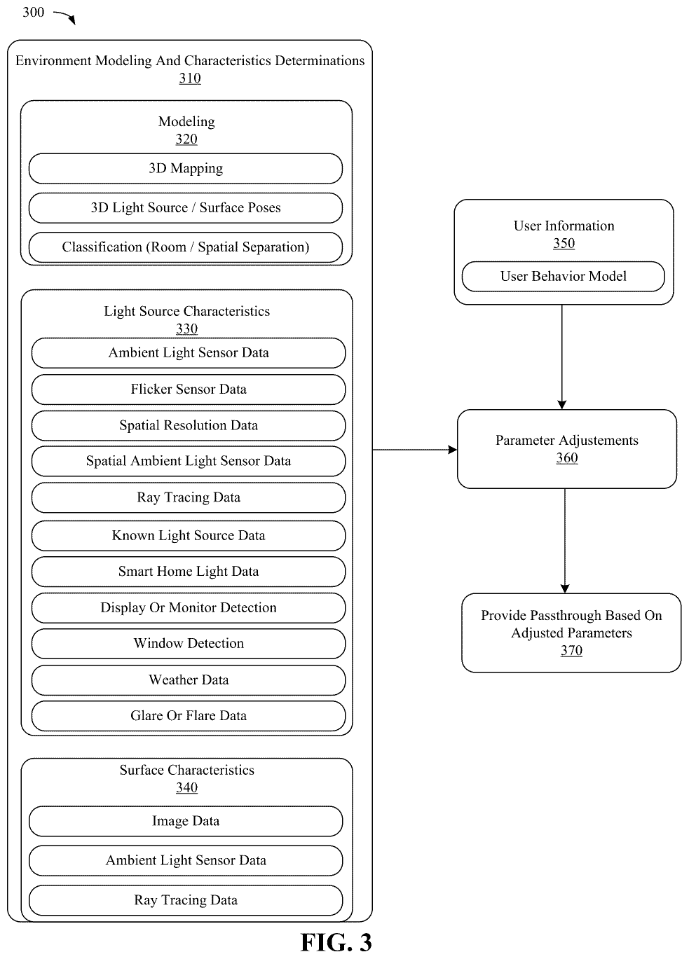

FIG. 3 illustrates a parameter adjustment. In this example, environment modeling and characteristic determinations are made (block 310) and used with user information (block 350) to provide parameter adjustments (block 360), which are used to provide passthrough video based on the adjusted parameters (block 370). The parameter adjustment process of FIG. 3 may be configured to improve camera parameter adjustments by replacing (or supplementing) image statistic information with environment modeling information and/or information about other circumstances of the experience.

The parameter adjustment process may involve adjusting camera and image processing parameters including, but not limited to, exposure, gain, tone-mapping, and color balance. In one example, tone mapping is adjusted based on modeling the environment and understanding (based in part on that modeling) the state of bright adaptation of the user's vision (e.g., how dilated the user's eyes may be, how much light the user's eyes are letting in currently, etc.). Such information may be used, for example, to clip and shift camera settings when the user is adapted to a bright environment. The parameter adjustment process may involve adjusting secondary image processing parameters such as noise-reduction and sharpness enhancement parameters.

In some implementations, parameter adjustments are based on camera characteristics (e.g., camera calibration), environment characteristic (e.g., image statistics, ambient light sensor (ALS) information, environment modeling, flicker detection, etc.), and user information (e.g., human preferences, manual tuning, user research and modeling).

In some implementations, parameters are adjusted based on criteria that attempt to provide a relatively stable color experience (e.g., consistent color temperature) over time. In some implementations, the parameters are adjusted based on criteria that attempt to balance dynamic range, image brightness stability, motion blur visibility, flicker visibility, banding visibility, and/or noise visibility.

Various techniques may be used to adjust parameters based on such criteria. Some exemplary techniques detect light source characteristics (block 330). This may involve detection of optical characteristics of one or more environment light sources. This may involve detecting brightness, color/spectrum, temporal brightness/flicker profile, physical technology (e.g., sequential RGB or not), spatial emission profile (e.g., spotlight versus global), light source classification (e.g., identifying whether a light source is a window, desk lamp, etc.), etc. The detection may involve detection methods that involve detecting ALS over time, using a flicker sensor to detect flicker over time, using a spatial resolution flicker sensor, using a spatial resolution ALS, using ray tracing, performing database look-ups of known light sources (e.g., based on light source make, model, etc.), using information available via smart home integration (e.g., smart home mapping information, smart device information, etc.), display/monitor detection (e.g., detection of a display based on computer vision or device-to-device communications), window detection, weather/forecast detection, use of date/time, time of year, year or other timing information, detection of glare and/or flare, etc.

Some exemplary techniques detect surface characteristics (block 340). This may involve detection of optical characteristics of one or more environment surfaces (e.g., wall surfaces, ceiling surfaces, floor surfaces, table surfaces, couch surfaces, etc.). This may involve detecting surface color, whether surfaces' optical properties are specular or diffuse, surface bidirectional reflectance distribution function (BRDF), transparency, etc. The detection may involve using image/camera data, ALS data, ray tracing data, machine learning, etc.

Some exemplary techniques model the environment (block 320). This may involve performing 3D mapping of the environment, detecting 3D light source/surface poses (i.e., 3D positions and orientations), classification (e.g., identifying the types of objects or rooms and/or characteristics such as separation of objects). The modeling (block 320) may be used to determine light source characteristics (block 330) and/or surface characteristics (block 340). 3D mapping of the environment may be based on various sources of information. For example, 3D mapping may be based on IMU data and camera data, VIO SLAM data, alternative environment mapping techniques, scene understanding techniques, semantic labeling/mapping techniques, etc.

3D mapping, e.g., of light sources and surface poses, may be integrated with a device's tracking system. The process may utilize device pose information, ALS data, flicker sensor data over time, spatial resolution flicker sensor data, spatial resolution ALS data, ray tracing data, multiple ALS/flicker/cameras directed in different direction, etc.

In some implementations, camera parameters are adjusted based on image statistics. For example, historical data of image statistics of when the device was directed in a particular direction at a particular location may be used to adjust current camera parameters (e.g., in similar circumstances). Some implementations scale historical data based on image statistics in certain circumstances, e.g., when the natural light is greater than a threshold proportion of the light coming into a camera.

The user information (block 350) may be based on a user behavior model. Such a model may detect or classify user movement, e.g., detecting if the user is static or near/approximately static (e.g., when the user is sitting down). Such a model may detect if the user is in a moving experience, e.g., walking, running, playing a game, etc. Such a model may detect if the user is transitioning to a different location or performing a particular type of movement (e.g., opening a door, walking down a corridor, etc.). A model may detect if the user is on a moving platform, e.g., a car, bus, train, plane, elevator, etc. Various method may be used to determine user information. Some implementations use a machine learning model that determine a type of use (e.g., use case detection) based on inputs such as, but not limited to, historical pose data, live pose data, eye tracking data, determining which apps are executing, where/what a user is moving towards, what a user is holding, where a user is looking, etc.

Some implementations predict the optical characteristics of light entering a camera at plausible poses in the environment. Plausible poses may be poses that the user is likely to move to within a threshold amount of time, e.g., within the next 10 seconds, 30 seconds, 1 minute, 2 minutes, etc., as determined by the device. Such plausible poses may be based on a 3D mapping of the environment, a user behavior model, time horizon data, etc. Some implementations perform ray tracing/rendering based on a camera's physical design, e.g., focal characteristics, f #, field of view (FOV), vignetting, responsivity, spectral QE of different color channels, transmittance, sensor timing/readout time, etc. Some implementations predict light entering a camera based on far field light mapping, occlusion mitigation/hallucination, flicker profile blending, camera shutter simulation (e.g., with global flicker profile), and/or color spectrum blending from multiple sources using camera spectral responsivity.

Some implementations determine brightness using high-level metric generation (e.g., on multiple time scales). For the short term, motion blur versus flicker versus noise visibility may be assessed. For the medium to long term, noise visibility versus dynamic range versus brightness stability may be assessed. In one example, there might be a bright lamp left of the user. While the lamp is not in direct view, every time the user looks left, the exposure of the cameras might have to be adjusted in order to avoid saturating the regions of the image around the lamp. This would cause the overall image brightness to ramp up and down, which could be objectionable to the user. Depending on how often the user looks in that direction the environment aware exposure might do one of three things. Some implementations reduce the dynamic range of the scene when the user is looking forward, to leave headroom (e.g., a reserved portion of the range) for the area around the lamp when the user looks left. This may be a good choice if the user looks left often and the device deems the content on the left to be important. Some implementations keep full dynamic range when the user looks forward and do not adjust the exposure when they look left. This would be a good decision if the user looks left often and the content around the lamp is deemed unimportant. Some implementations keep full dynamic range and adjust the exposure differently when the user looks forward and left. This is a good choice if the user does not look left often and this is a new situation.

Some implementations utilize a cost function optimization to determine optimal camera parameters. This may involve, as examples, increasing exposure time to reduce noise, increase motion blur, and/or increase saturated regions. A cost function may be configured to account for objectionability of motion blur (B), objectionability of noise (N), and/or objectionability of highlight clipping (C). A cost function may be generated based on various parameters and information (e.g., user study, environment, scene semantics). An exemplary cost function is:

$$cost = b * B + n * N + c * C , where b , n , c are tuned weights and B , N , C are objectionability functions of exposure ( and other parameters )$$

The optimal exposure may be determined, for example, by argmin_on_exposure(cost).

Some implementations perform mitigations for unmapped environments, e.g., ignoring certain zones based on virtual windows blocking passthrough, clipped light sources, etc. Some implementations ignore certain zones within the environment, e.g., ignoring areas corresponding to TVs, screens, etc., that have significant (e.g., more than a threshold amount) of change. Some implementations utilize zones in which camera settings are stabilized, e.g., based on 3D position, orientation of device, and/or image stats from sensors and detection processes.

Some implementations, adjust camera color parameters to control room color temperature, hand room transitions, mitigate for unmapped environments, account for skin and/or skin color stabilization, etc.

Some implementations utilize modeling of an environment (e.g., block 320). Such modeling may utilize one or more mapping processes. An exemplary mapping process may use various context sources and sensor sources for information. Such data may be provided to a frontend encoder. A temporal source may provide time/date information. An algorithms source may provide scene semantics, 2D/3D object pose, and/or lighting estimation. An ALS may provide brightness/color information. One or more IMUs may provide acceleration/gyroscope information. A flicker sensor (or other light sensor) may provide flicker or other light attribute information. An RGB sensor may provide passthrough image data. A greyscale sensor may provide greyscale image data of the environment.

Context and sensor-based information may be used, for example, by frontend encoder to generate a temporospatial map of the environment. Such a temporospatial map may be localized. If it corresponds to a known scene, the information is used to update, e.g., updating an existing map. If it corresponds to an unknown scene, a new embedding, sensor information (e.g., greyscale sensor data, etc.) may be used for mapping, e.g., VIO/SLAM mapping, and a 3D device pose and/or feature map (e.g., a sparse feature map) may be provided. The temporal light map and related information may be provided to a backend encoder, which may use the map to for display control, camera control, system control, algorithms control, etc., to address image quality, e.g., brightness, color, exposure, flicker, tone mapping, sharpening, noise reduction, motion blur, etc.

In one example, a user enters a new room and the user's device cannot localize and thus the device operates in a continuous control loop. As the user looks around the room, new lighting observations are added to a VIO map (e.g., 3D Pose tagged additions). Once there are enough samples added to light map, the device changes its update control loop (e.g., to use less frequent updates).

In one example, a user enters a room for a second or subsequent time, where the room has an existing light/VIO map. The device uses sensor data to localize into the 3D map (e.g., VIO) and obtains lighting, surface, or other environment information. This may involve looking up the nearest neighboring stored key pose and looking up lighting or surface observations from that perspective. A camera control loop may run with additional context to optimize the system, e.g., based on determining that there are existing flicker sources from that perspective.

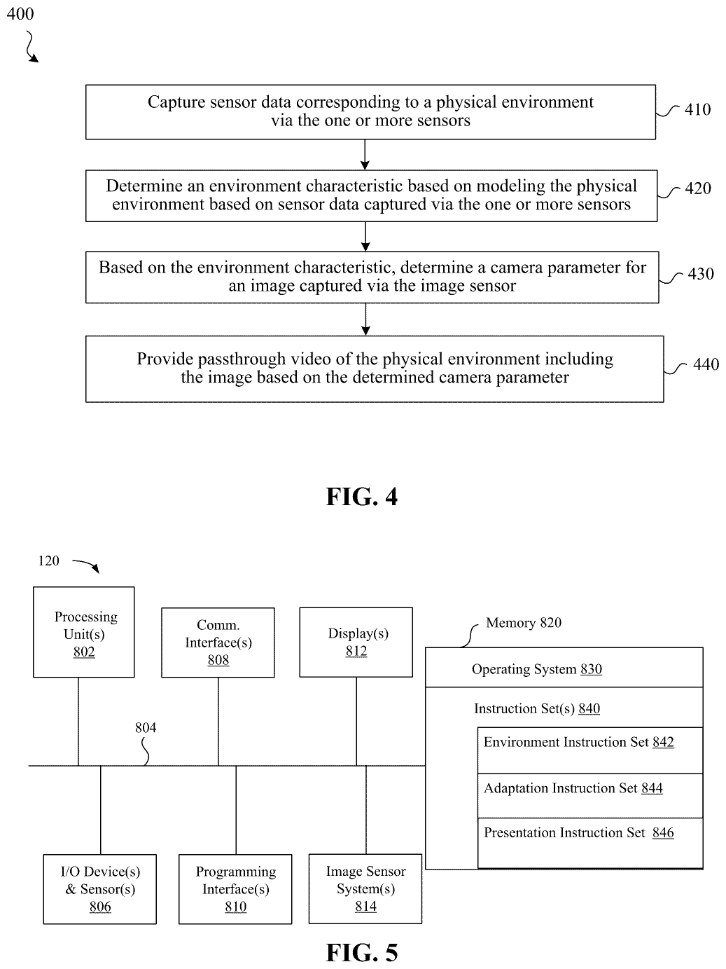

FIG. 4 is a flowchart illustrating an exemplary method 400 of providing passthrough video based on adjusting camera parameters. In some implementations, the method 400 is performed by a device (e.g., electronic device 120 of FIG. 1). The method 400 can be performed using an electronic device or by multiple devices in communication with one another. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 may be performed at a head-mounted device (HMD) having a processor and one or more outward-facing cameras, e.g., one or more left-eye outward-facing cameras associated with a left-eye viewpoint and/or one or more right-eye outward-facing cameras associated with a right-eye viewpoint.

At block 410, the method 400 involves capturing sensor data corresponding to a physical environment via the one or more sensors. This may involve capturing image data, capturing depth data, capturing motion data, etc.

At block 420, the method 400 involves determining an environment characteristic based on modeling the physical environment based on sensor data captured via the one or more sensors. This may involve determining environment light source optical characteristics, environment surfaces optical characteristics, a 3D mapping of the environment, a user behavior in the environment, a prediction of optical characteristics of light coming in the camera, etc. Determining the environment characteristic may comprise detection of an environment light source optical characteristic comprising brightness, color, temporal brightness, flicker profile, physical technology, spatial emission profile, or light source classification.

The environment light source optical characteristics is determined by: analyzing ALS data received over time; analyzing flicker sensor data received over time; analyzing spatial resolution data; analyzing spatial ALS data; analyzing ray tracing data; accessing a database of known light sources; accessing smart home light data; display or monitor detection; window detection; accessing weather data; and/or assessing glare or flare data.

Determining the environment characteristic may comprise detection of an environment surface optical characteristic comprising color, specular characteristic, diffuse characteristic, reflectance characteristic, or transparency characteristic. The environment surface optical characteristics may be determined by: analyzing image data of the physical environment; analyzing ALS data; and/or analyzing ray tracing data.

Modeling the physical environment may comprise generating a 3D mapping of the physical environment based on: inertial measurement unit (IMU) data; camera image data; visual inertial odometry (VIO) data; and/or a scene understanding process. Modeling the physical environment may comprise, using motion tracking data to: generate 3D poses of light sources in the physical environment; and/or generate 3D poses of surfaces in the physical environment. Modeling may involve determining a far field light background, e.g., for more uncertain cases. The modeling may be based on: analyzing ALS data received over time; analyzing flicker sensor data received over time; analyzing spatial resolution data; analyzing spatial ALS data; and/or analyzing ray tracing data. Modeling the physical environment may comprise room-based classification of the physical environment or spatial separation classification of the physical environment. Modeling the physical environment may be based on: previously-obtained image statistic data corresponding to one or more viewpoints within the physical environment; and/or scaling historical data based on proportion light in the physical environment corresponding to natural light. Modeling the physical environment may comprise analyzing one or more images to determine image statistics or semantics corresponding to object types depicted in the images. Modeling the physical environment may comprise identifying one or more light source location based on data from one or more ambient light sensors or flicker sensors.

Determining the environment characteristic based on modeling the physical environment may comprise predicting an optical characteristic of light entering the image sensor at one or more plausible poses in the physical environment. The one or more plausible poses are determined based on a 3D mapping of the physical environment, a user behavior model, or a time horizon. Predicting the optical characteristics of the light entering the image sensor may comprise ray tracing based on image sensor physical design, focal distance, aperture size, field of view, vignetting, responsivity, spectral quantum efficiency (QE) of different color channels, transmittance, or sensor timing or sensor readout time. Predicting the optical characteristics of the light entering the image sensor may comprise image sensor calibration; a far-field light map; occlusion mitigation or hallucination; far field light map; flicker profile blending; image sensor shutter simulation; and/or color spectrum blending using spectral responsivity.

Determining the camera parameters may be based on a cost function-based optimization.

Determining the camera parameters may be based on a mitigation that accounts for unmapped environments. Determining the camera parameter may comprise determining one or more zones in which the camera parameter is to be stabilized. Determining the camera parameter may be based on room color temperature, room transition handling, or skin color stabilization.

At block 430, based on the environment characteristic, the method 400 involves determining a camera parameter for an image captured via the image sensor. Camera parameters include, but are not limited to, exposure, gain, tone mapping, color balance, noise reduction, sharpness enhancement, etc. Camera characteristics and/or human preferences may also be used in determining/adjusting the camera parameter.

At block 440, the method 400 involves providing (e.g., capturing, modifying, supplementing, displaying, etc.) passthrough video of the physical environment including the image based on the determined camera parameter. The passthrough may be provided based on a user behavior model. Such a user behavior model may be based on detecting if a user is approximately static, moving, transitioning to a different location, or on a moving platform. The user behavior model may be based on: historical user pose data; live user pose data; eye tracking; and/or identifying one or more apps currently executing.

Providing the passthrough video may comprise accounting for motion blur, flicker visibility, noise visibility, dynamic range, and brightness stability.

Providing the passthrough video may be further based on a camera characteristic and/or a user preference.

The passthrough video may be provided based on stabilizing color temperature over time. The passthrough video may be provided based on dynamic range, image brightness stability, motion blur visibility, flicker visibility, banding visibility, and noise visibility.

FIG. 5 is a block diagram illustrating exemplary components of the electronic device 120 configured in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 802 (e.g., DSPs, microprocessors, ASICS, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 810, one or more displays 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 812 are configured to present a view of a physical environment or a graphical environment (e.g., a 3D environment) to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. In one example, the electronic device 120 includes a single display. In another example, the electronic device 120 includes a display for each eye of the user.

In some implementations, the one or more image sensor systems 814 are configured to obtain image data that corresponds to at least a portion of the physical environment 100. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, depth cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data. In various implementations, the one or more image sensor systems include an optical image stabilization (OIS) system configured to facilitate optical image stabilization according to one or more of the techniques disclosed herein.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of electrical charge. In some implementations, the instruction set(s) 840 are software that is executable by the one or more processing units 802 to carry out one or more of the techniques described herein.

The instruction set(s) 840 include an environment instruction set 842, an adaptation instruction set 844, and a presentation instruction set 846. The instruction set(s) 840 may be embodied a single software executable or multiple software executables. In alternative implementations software is replaced by dedicated hardware, e.g., silicon. In some implementations, the environment instruction set 842 is executable by the processing unit(s) 802 (e.g., a CPU) to create, update, or use a 3D mapping or other environment characteristics as described herein. In some implementations, the adaption instruction set 844 is executable by the processing unit(s) 802 (e.g., a CPU) to determine parameters of the one or more cameras of the electronic device 120 to improve image capture as described herein. In some implementations, the presentation instruction set 846 is executable by the processing unit(s) 802 (e.g., a CPU) to present captured video content (e.g., as one or more live video feeds or other passthrough video) as described herein. To these ends, in various implementations, these units include instructions and/or logic therefor, and heuristics and metadata therefor.

Although the instruction set(s) 840 are shown as residing on a single device, it should be understood that in other implementations, any combination of the elements may be located in separate computing devices. Moreover, FIG. 4 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations, but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device having a processor and one or more sensors, the one or more sensors comprising an image sensor:
capturing sensor data corresponding to a physical environment via the one or more sensors;
determining an environment characteristic based on modeling the physical environment based on sensor data captured via the one or more sensors;
based on the environment characteristic, determining a camera parameter for an image captured via the image sensor; and
providing passthrough video of the physical environment including the image based on the determined camera parameter.

2. The method of claim 1, wherein determining the environment characteristic comprises detection of an environment light source optical characteristic comprising brightness, color, temporal brightness, flicker profile, physical technology, spatial emission profile, or light source classification.

3. The method of claim 2, wherein the environment light source optical characteristics is determined by:
analyzing ambient light sensor (ALS) data received over time;
analyzing flicker sensor data received over time;
analyzing spatial resolution data;
analyzing spatial ALS data;
analyzing ray tracing data;
accessing a database of known light sources;
accessing smart home light data;
display or monitor detection;
window detection;
accessing weather data; or
assessing glare or flare data.

4. The method of claim 1, wherein determining the environment characteristic comprises detection of an environment surface optical characteristic comprising color, specular characteristic, diffuse characteristic, reflectance characteristic, or transparency characteristic.

5. The method of claim 4, wherein the environment surface optical characteristics is determined by:
analyzing image data of the physical environment;
analyzing ambient light sensor (ALS) data; or
analyzing ray tracing data.

6. The method of claim 1, wherein modeling the physical environment comprises generating a 3D mapping of the physical environment based on:
inertial measurement unit (IMU) data;
camera image data;
visual inertial odometry (VIO) data;
a scene understanding process; or
simultaneous localization and mapping (SLAM).

7. The method of claim 1, wherein modeling the physical environment comprises, using motion tracking data, to:
generate 3D poses of light sources in the physical environment; and
generate 3D poses of surfaces in the physical environment.

8. The method of claim 7, wherein the modeling is based on:
analyzing ambient light sensor (ALS) data received over time;
analyzing flicker sensor data received over time;
analyzing spatial resolution data.
analyzing spatial ALS data; or
analyzing ray tracing data.

9. The method of claim 1, wherein modeling the physical environment comprises:
room-based classification of the physical environment or spatial separation classification of the physical environment, or
or far-field light map modeling.

10. The method of claim 1, wherein modeling the physical environment is based on:
previously-obtained image statistic data corresponding to one or more viewpoints within the physical environment; and
scaling historical data based on proportion light in the physical environment corresponding to natural light.

11. The method of claim 1, wherein the passthrough is provided based on a user behavior model, the user behavior model based on:
detecting if a user is approximately static, moving, transitioning to a different location, or on a moving platform.

12. The method of claim 11, wherein the user behavior model is based on:
historical user pose data;
live user pose data;
eye tracking; or
identifying one or more apps currently executing.

13. The method of claim 1, wherein determining the environment characteristic based on modeling the physical environment comprises predicting an optical characteristics of light entering the image sensor at one or more plausible poses in the physical environment.

14. The method of claim 13, wherein the one or more plausible poses are determined based on a 3D mapping of the physical environment, a user behavior model, or a time horizon.

15. The method of claim 13, wherein predicting the optical characteristics of the light entering the image sensor comprises:
ray tracing based on image sensor physical design, focal distance, aperture size, field of view, vignetting, responsivity, spectral quantum efficiency of different color channels, transmittance, sensor timing, sensor readout time, or far-field light map modeling;
image sensor calibration;
occlusion mitigation or hallucination;
far field light map;
flicker profile blending;
image sensor shutter simulation; or
color spectrum blending using spectral responsivity.

16. The method of claim 1, wherein providing the passthrough video comprises accounting for motion blur, flicker visibility, noise visibility, dynamic range, and brightness stability.

17. The method of claim 1, wherein determining the camera parameters is based on a cost function-based optimization.

18. The method of claim 1, wherein determining the camera parameter is based on a mitigation that accounts for unmapped environments.

19. The method of claim 1, wherein determining the camera parameters comprises determining one or more zones in which the camera parameter is to be stabilized.

20. The method of claim 1, wherein determining the camera parameters is based on room color temperature, room transition handling, or skin color stabilization.

21. The method of claim 1, wherein the camera parameter is an exposure, gain, tone mapping, or color balance.

22. The method of claim 1, wherein the camera parameter is a noise reduction parameter or a sharpness enhancement parameter.

23. The method of claim 1, wherein providing the passthrough video is based on further based on a camera characteristic.

24. A head-mounted device (HMD) comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
capturing sensor data corresponding to a physical environment via the one or more sensors;
determining an environment characteristic based on modeling the physical environment based on sensor data captured via the one or more sensors;
based on the environment characteristic, determining a camera parameter for an image captured via the image sensor; and
providing passthrough video of the physical environment including the image based on the determined camera parameter.

25. A non-transitory computer-readable storage medium, storing program instructions computer-executable on a computer to perform operations comprising:
capturing sensor data corresponding to a physical environment via the one or more sensors;
determining an environment characteristic based on modeling the physical environment based on sensor data captured via the one or more sensors;
based on the environment characteristic, determining a camera parameter for an image captured via the image sensor; and
providing passthrough video of the physical environment including the image based on the determined camera parameter.
